(19) United States
(12) Patent Application Publication
(10) Pub. No.: US 2004/0081841 A1
(43) Pub. Date: Apr. 29, 2004

(54) Magnetic memory device using damascene process and manufacturing method thereof

(76) Inventor: Kentaro Nakajima, Tokyo (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/303,925

(22) Filed: Nov. 26, 2002

(30) Foreign Application Priority Data
Oct. 25, 2002 (JP) 2002-311495

(51) Int. Cl. B32B 25/04

(52) U.S. Cl. 428/492; 428/900

(57) ABSTRACT

A magnetic memory device includes a first wiring which runs in the first direction, a first metal layer which is arranged above the first wiring, a first magneto resistive effect element which is arranged in a predetermined region on the first metal layer, a first contact layer which is arranged on the first magneto resistive effect element, a second wiring which runs in the second direction different from the first direction, is arranged on the first contact layer, and has a projection that covers the top of the first contact layer, and a first insulating film which is buried around the first metal layer, first magneto resistive effect element, first contact layer, and second wiring, and has a surface flush with that of the second wiring.

### CROSS-REFERENCE TO RELATED APPLICATIONS

This application is based upon and claims the benefit of priority from the prior Japanese Patent Application No. 2002-311495, filed Oct. 25, 2002, the entire contents of which are incorporated herein by reference.

### BACKGROUND OF THE INVENTION

1. Field of the Invention

The present invention relates to an information reproduction technique using a ferromagnet and, more particularly, to a magnetic memory device using a magneto resistive effect element and a manufacturing method thereof.

2. Description of the Related Art

A magnetic random access memory (to be simply referred to as an MRAM hereinafter) is a general term for solid-state memories capable of rewriting, holding, and reading out recorded information at any time by using the magnetization direction of a ferromagnet serving as an information recording medium.

An MRAM memory cell generally has a layered structure of a plurality of ferromagnets. In information recording, the relative magnetization arrangement of a plurality of ferromagnets which constitute a memory cell is changed parallel or anti-parallel. The parallel and anti-parallel states are made to correspond to binary data “1” and “0”, respectively. In information write, a current is supplied to write lines arranged in a cross stripe shape. A current magnetic field generated by the current reverses the magnetization direction of the ferromagnet of each cell. This MRAM is a nonvolatile memory in which power consumption in recording/holding is 0 in principle and the recorded information is kept held even after power-off. The recorded information is read out using a so-called magneto resistive effect. With this effect, the electrical resistance of the memory cell changes depending on the relative angle between the magnetization direction of a ferromagnet which constitutes the cell and the sense current or the relative magnetization angle between a plurality of ferromagnetic layers.

From comparison between the MRAM function and the function of a semiconductor memory using a conventional dielectric, the MRAM has many advantages: (1) the MRAM is completely nonvolatile and enables rewrite 10¹⁵ times or more, (2) the MRAM allows nondestructive read and can shorten the read cycle because of no need for refresh operation, and (3) the MRAM is more resistant to radiation than a charge storage memory cell. The degree of integration of MRAMs per unit area, and the write and read times are predicted to be almost the same as those of a DRAM. Applications of MRAMs with the significant “nonvolatile” feature to the external recording device of a portable device, hybrid LSI purposes, and the main memory of a personal computer are expected.

MRAMs which are being put into practical use adopt an element exhibiting the tunnel magneto-resistance effect (to be simply referred to as a TMR effect hereinafter) for a memory cell (see, e.g., Roy Scheuerlein, et al., A 10 ns Read and Write Non-Volatile Memory Array Using a Magnetic Tunnel Junction and FET Switch in each Cell, “2000 ISSCC Digest of Technical Papers”, (USA), February, 2000, pp. 128-129). The element exhibiting the TMR effect (to be simply referred to as an MTJ (Magnetic Tunnel Junction) element hereinafter) is mainly formed from a three-layered film of a ferromagnet layer/insulating layer/ferromagnet layer. A current tunnels through the insulating and flows. The tunnel resistance value changes in proportion to the cosine of the relative magnetization angle between the two ferromagnetic metal layers, and maximizes when their magnetization directions become anti-parallel to each other. For example, in a tunnel junction of NiFe/Co/Al₂O₃/Co/NiFe, a magnetic resistance change ratio exceeding 25% is found in a low magnetic field of 50 OeV or less (see, e.g., M. Sato, et al., Spin-Valve-Like Properties and Annealing Effect in Ferromagnetic Tunnel Junctions, “IEEE Trans. Mag.”, (USA), 1997, Vol. 33, No. 5, pp. 3553-3555). Known structures of the MTJ element are a so-called spin-valve structure in which the magnetization direction is fixed by arranging an anti-ferromagnet adjacent to one ferromagnet in order to improve the magnetic field sensitivity (see, e.g., M. Sato, et al., Spin-Valve-Like Properties of Ferromagnetic Tunnel Junctions, “Jpn. J. Appl. Phys.”, 1997, Vol. 36, Part 2, pp. 200-201), and a structure using a double tunnel barrier in order to improve the bias dependence of the magnetic resistance change ratio (see, e.g., K. Inomata, et al., Spin-dependent tunneling between a soft ferromagnetic layer and hard magnetic nano particles, “Jpn. J. Appl. Phys.”, 1997, Vol. 36, Part 2, pp. 1380-1383).

In the memory cell portion of the conventional MRAM, as shown in FIGS. 15A, 15B, and 16, an MTJ element 19 is arranged at the intersection between a bit line 25 and a write word line 10. The MTJ element 19 is connected to a switching element (not shown) Tr1 such as a transistor or diode via a lower metal layer 13 and first contact 12.

The MRAM memory cell portion is formed by the following method. The conventional method will be explained with reference to FIGS. 17A to 26B.

As shown in FIGS. 17A and 17B, a lower metal layer 13 is formed on an insulating film 11 and first contact 12, and an MTJ material layer 14 is formed on the lower metal layer 13. First and second hard masks 15 and 16 of two layers are stacked on the MTJ material layer 14.

As shown in FIGS. 18A and 18B, the second hard mask 16 is selectively etched to transfer the shape of the MTJ element 19 onto the second hard mask 16.

As shown in FIGS. 19A and 19B, the first hard mask 15 is etched using the second hard mask 16, transferring the shape of the MTJ element 19 onto the first hard mask 15.

As shown in FIGS. 20A and 20B, the second hard mask 16 is removed.

As shown in FIGS. 21A and 21B, the MTJ material layer 14 is etched using the first hard mask 15, patterning the MTJ material layer 14 into the shape of the MTJ element 19.

As shown in FIGS. 22A and 22B, an insulating film 21a is formed on the lower metal layer 13 and first hard mask 15, and patterned into a desired shape of the lower metal layer 13.

As shown in FIGS. 23A and 23B, the lower metal layer 13 is etched using the insulating film 21a.

As shown in FIGS. 24A and 24B, an insulating film 21b is formed on the insulating films 11 and 21a.

As shown in FIGS. 25A and 25B, the surfaces of the insulating films 21a and 21b are planarized by, e.g., CMP (Chemical Mechanical Polish), exposing the surface of the first hard mask 15.

As shown in FIGS. 26A and 26B, an insulating film 21c is formed on the insulating film 21b and first hard mask 15. A trench 22 is formed in the insulating film 21c, and a barrier metal layer 24, Al film, and barrier metal layer 26 are sequentially formed in the trench 22 and on the insulating film 21c. The barrier metal layer 24, Al film, and barrier metal layer 26 are selectively etched by, e.g., RIE, thus forming a bit line 25 connected to the MTJ element 19 via a contact 23. In this manner, the MRAM memory cell portion is formed.

In the conventional MRAM, the Al bit line 25 and MTJ element 19 are spaced apart from each other by a total film thickness X′ of the first hard mask 15 and contact 23. To apply a sufficiently large magnetic field to the MTJ element 19 in order to write data in the MTJ element 19, a write current supplied to the bit line 25 must be increased to a certain degree. However, meeting these demands is difficult for the bit line 25 made of Al which readily causes electromigration upon reception of a high-density current.

### BRIEF SUMMARY OF THE INVENTION

A magnetic memory device according to the first aspect of the present invention comprises a first wiring which runs in a first direction, a first metal layer which is arranged above the first wiring, a first magneto resistive effect element which is arranged in a predetermined region on the first metal layer, a first contact layer which is arranged on the first magneto resistive effect element, a second wiring which runs in a second direction different from the first direction, is arranged on the first contact layer, and has a projection that covers top of the first contact layer, and a first insulating film which is buried around the first metal layer, the first magneto resistive effect element, the first contact layer, and the second wiring, and has a surface flush with a surface of the second wiring.

A magnetic memory device manufacturing method according to the second aspect of the present invention comprises sequentially forming a metal layer, a magneto resistive effect film, and a mask layer on a first insulating film, selectively removing the magneto resistive effect film by using the mask layer to form a magneto resistive effect element, selectively removing the metal layer to divide the metal layer into cells, forming a second insulating film which covers the metal layer and the magneto resistive effect element, planarizing the second insulating film to a predetermined thickness, selectively etching the second insulating film to form a trench from which top of the mask layer is exposed, and forming a wiring material in the trench to form a wiring having a projection which covers the top of the mask layer.

### BRIEF DESCRIPTION OF THE SEVERAL VIEWS OF THE DRAWING

FIG. 1A is a sectional view showing a magnetic memory device in the bit line running direction according to the first embodiment of the present invention;

FIG. 1B is a sectional view showing the magnetic memory device in the write word line running direction according to the first embodiment of the present invention;

FIGS. 2A, 3A, 4A, 5A, 6A, 7A, 8A, 9A, 10A, 11A, and 12A are sectional views, respectively, showing steps in manufacturing the magnetic memory device in the bit line running direction according to the first embodiment of the present invention;

FIGS. 2B, 3B, 4B, 5B, 6B, 7B, 8B, 9B, 10B, 11B, and 12B are sectional views, respectively, showing steps in manufacturing the magnetic memory device in the write word line running direction according to the first embodiment of the present invention;

FIG. 13 is a sectional view showing a magnetic memory device according to the second embodiment of the present invention;

FIG. 14 is a sectional view showing another magnetic memory device according to the second embodiment of the present invention;

FIG. 15A is a plan view showing a conventional magnetic memory device;

FIG. 15B is a sectional view showing the magnetic memory device taken along the line XVB-XVB in FIG. 15A;

FIG. 16 is a sectional view showing a conventional magnetic memory device having a memory cell portion and peripheral circuit portion;

FIGS. 17A, 18A, 19A, 20A, 21A, 22A, 23A, 24A, 25A, and 26A are sectional views, respectively, showing steps in manufacturing the conventional magnetic memory device in the bit line running direction; and

FIGS. 17B, 18B, 19B, 20B, 21B, 22B, 23B, 24B, 25B, and 26B are sectional views, respectively, showing steps in manufacturing the conventional magnetic memory device in the write word line running direction.

### DETAILED DESCRIPTION OF THE INVENTION

Preferred embodiments of the present invention will be described below with reference to the several views of the accompanying drawing. In the following description, the same reference numerals denote the same parts throughout the drawing.

### First Embodiment

In the first embodiment, a bit line is arranged close to an MTJ element by forming by a damascene process a bit line arranged above a magneto resistive effect element (to be referred to as an MTJ (Magnetic Tunnel Junction) element hereinafter).

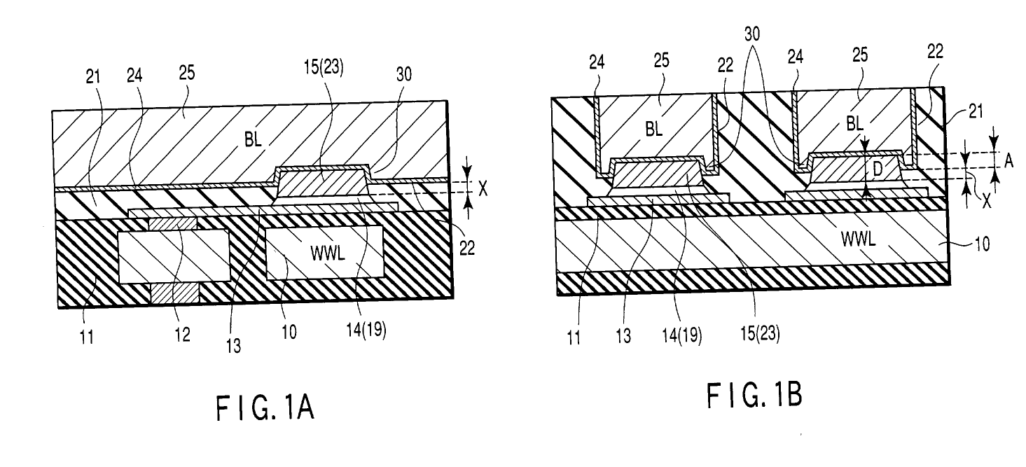

FIGS. 1A and 1B are sectional views showing a magnetic memory device according to the first embodiment of the present invention. As shown in FIGS. 1A and 1B, a write word line 10 and bit line 25 run in directions different from each other (directions perpendicular to each other in this embodiment). An MTJ element 19 is arranged at the intersection between the write word line 10 and the bit line 25. The MTJ element 19 is connected to a switching element (not shown) such as a transistor or diode via a lower metal layer 13 and first contact 12. The MTJ element 19 is connected to the bit line 25 via a second contact 23. The second contact 23 is formed from a first hard mask 15 used to pattern the MTJ element 19, and thus has almost the same planar shape as that of the MTJ element 19.

In the first embodiment of the present invention, the bit line 25 has a damascene structure made of, e.g., a Cu film. That is, the surface of the bit line 25 and that of an insulating film 21 are almost flush with each other. The bit line 25 has a projection 30 which covers the top of the second contact 23. The projection 30 projects from the surface of the second contact 23 toward the MTJ element 19 with a thickness A which is 10% or more a film thickness D of the second contact 23. The projection 30 of the bit line 25 and the MTJ element 19 are spaced apart from each other by only a distance X shorter than the film thickness D of the second contact 23.

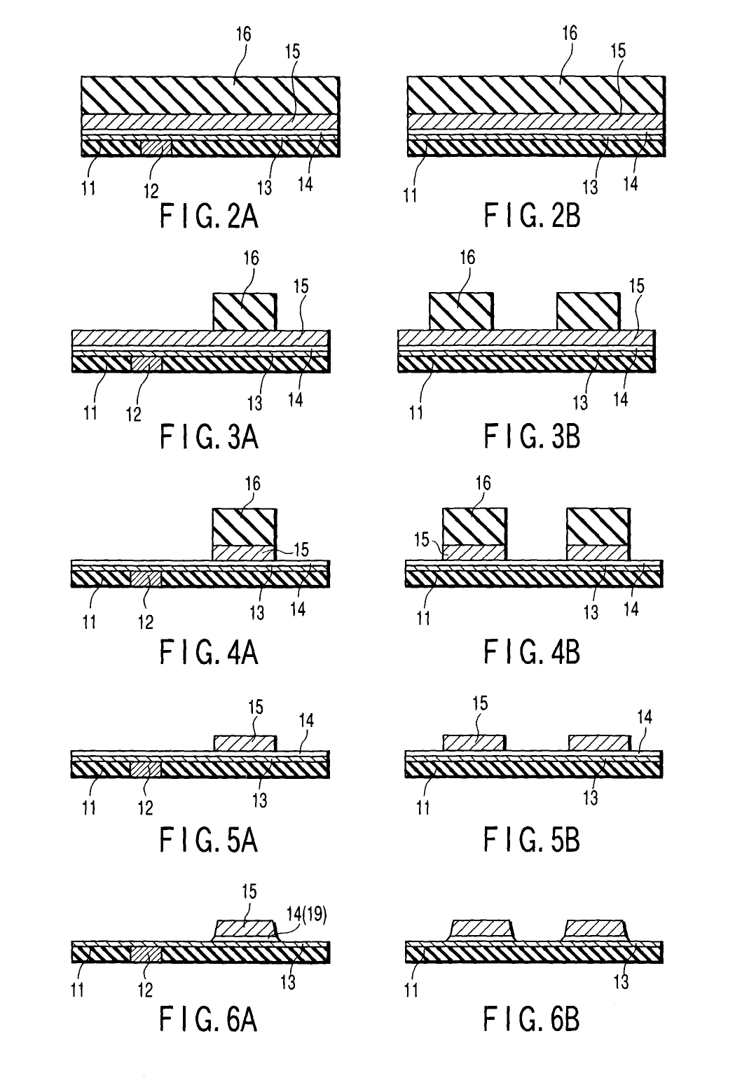

FIGS. 2A and 2B to FIGS. 12A and 12B are sectional views, respectively, showing steps in manufacturing the magnetic memory device according to the first embodiment of the present invention. A method of manufacturing the magnetic memory device according to the first embodiment will be explained. Steps after the write word line 10 and first contact 12 are formed will be described.

As shown in FIGS. 2A and 2B, a lower metal layer 13 is formed on a first insulating film 11 and first contact 12, and an MTJ material layer 14 is formed on the lower metal layer 13. First and second hard masks 15 and 16 of two layers are stacked on the MTJ material layer 14. For example, the first hard mask 15 is made of a conductive film, and the second hard mask 16 is made of a nonconductive film (insulating film). The second hard mask 16 may be formed from a conductive film.

As shown in FIGS. 3A and 3B, the second hard mask 16 is selectively etched to transfer the shape of the MTJ element 19 onto the second hard mask 16.

As shown in FIGS. 4A and 4B, the first hard mask 15 is etched using the second hard mask 16, transferring the shape of the MTJ element 19 onto the first hard mask 15.

As shown in FIGS. 5A and 5B, the second hard mask 16 is removed.

As shown in FIGS. 6A and 6B, the MTJ material layer 14 is etched using the first hard mask 15, patterning the MTJ material layer 14 into the shape of the MTJ element 19.

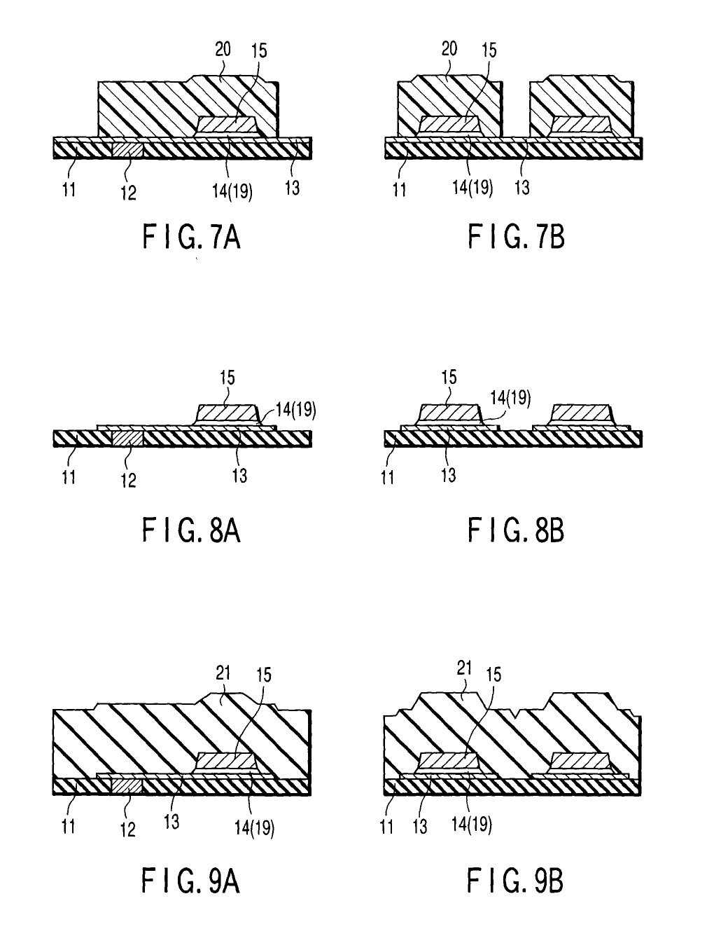

As shown in FIGS. 7A and 7B, a photoresist 20 is applied to the lower metal layer 13 and first hard mask 15, and the lower metal layer 13 is patterned into a desired shape. This divides the lower metal layer 13 into cells.

As shown in FIGS. 8A and 8B, the lower metal layer 13 is etched using the photoresist 20. After that, the photoresist 20 is removed. Note that the mask used to pattern the lower metal layer 13 may be an insulating film in place of the photoresist 20.

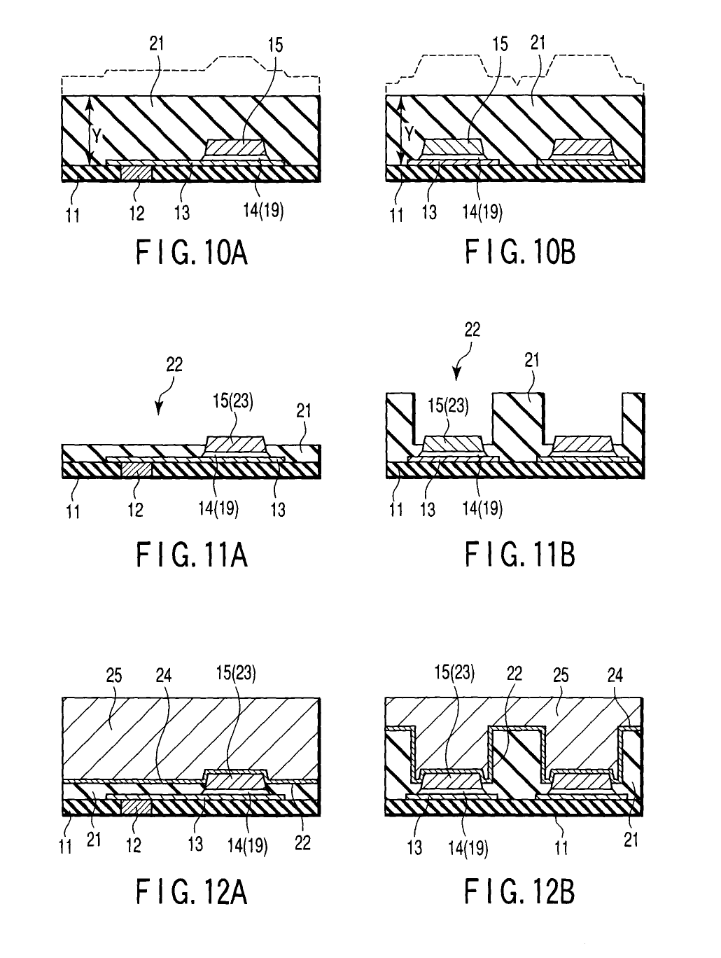

As shown in FIGS. 9A and 9B, a second insulating film 21 is formed on the first insulating film 11, lower metal layer 13, and first hard mask 15.

As shown in FIGS. 10A and 10B, the uneven surface of the second insulating film 21 is planarized by, e.g., CMP (Chemical Mechanical Polish). A film thickness Y of the second insulating film 21 after planarization must be adjusted in consideration of a predetermined thickness of the bit line 25 to be formed later. In other words, the film thickness of the second insulating film 21 on the first hard mask 15 is adjusted to almost the film thickness of the bit line 25.

The second insulating film 21 may be planarized as follows. A planarization resist or similar agent is applied to the entire surface in advance. After a flat surface is formed, the entire surface of the second insulating film 21 is etched back by RIE (Reactive Ion Etching), which realizes planarization. Examples of the planarization resist or similar agent are a photosensitive resin, non-photosensitive resin, and organic glass. A thermosetting material can be utilized. At this time, the second insulating film 21 which covers the MTJ element 19, and the planarization resist or similar agent must be almost equal in etching rate in the etching process.

As shown in FIGS. 11A and 11B, the second insulating film 21 is selectively etched using, e.g., a resist (not shown), forming a trench 22 in the shape of the bit line 25. Etching is continued until the trench 22 reaches the first hard mask 15. As a result, the second contact 23 is formed from the first hard mask 15 in self-alignment with the trench 22 of the bit line 25.

The end of etching to form the trench 22 is detected by detecting the component of the first hard mask 15 using a known monitoring method such as plasma emission spectrometry or secondary ion mass spectrometry. To increase the detection sensitivity, a dummy MTJ element and first hard mask which are originally unnecessary may be arranged at a peripheral circuit portion around the memory cell at the same levels as the MTJ element 19 and first hard mask 15.

As shown in FIGS. 12A and 12B, a barrier metal layer 24 is formed in the trench 22, and the material layer (e.g., a Cu film) of the bit line 25 is formed on the barrier metal layer 24.

As shown in FIGS. 1A and 1B, the barrier metal layer 24 and material layer are planarized using, e.g., CMP, forming the bit line 25 from the Cu film. Consequently, the memory cell portion of the magnetic memory device is formed.

According to the first embodiment, the wiring material of the bit line 25 is a Cu film, and the bit line 25 is formed by a damascene process. This makes it possible to form the projection 30 which so projects as to cover the top of the contact 23. The mask layer 15 is used as the contact 23, and the distance X between the bit line 25 and the MTJ element 19 becomes shorter than the conventional one. A sufficiently large magnetic field can be applied to the MTJ element 19 without supplying a large current to the bit line 25, and the write current can be reduced.

The Cu film capable of suppressing electromigration is employed as the wiring material of the bit line 25, and can increase the wiring current density in comparison with the conventional Al film.

The contact 23 which connects the MTJ element 19 and bit line 25 can be formed in self-alignment with the trench 22 for forming the bit line 25. Compared to the prior art, the number of steps can be decreased to reduce the cost.

### Second Embodiment

In the second embodiment, a plurality of MTJ elements are stacked in a direction (longitudinal direction) perpendicular to the surface of a semiconductor substrate.

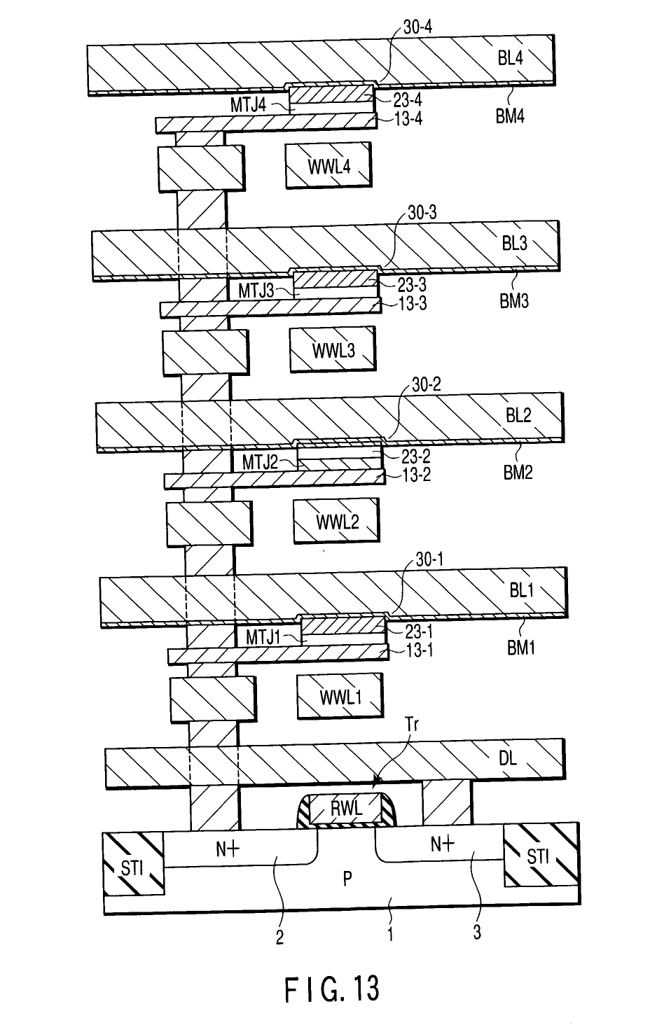

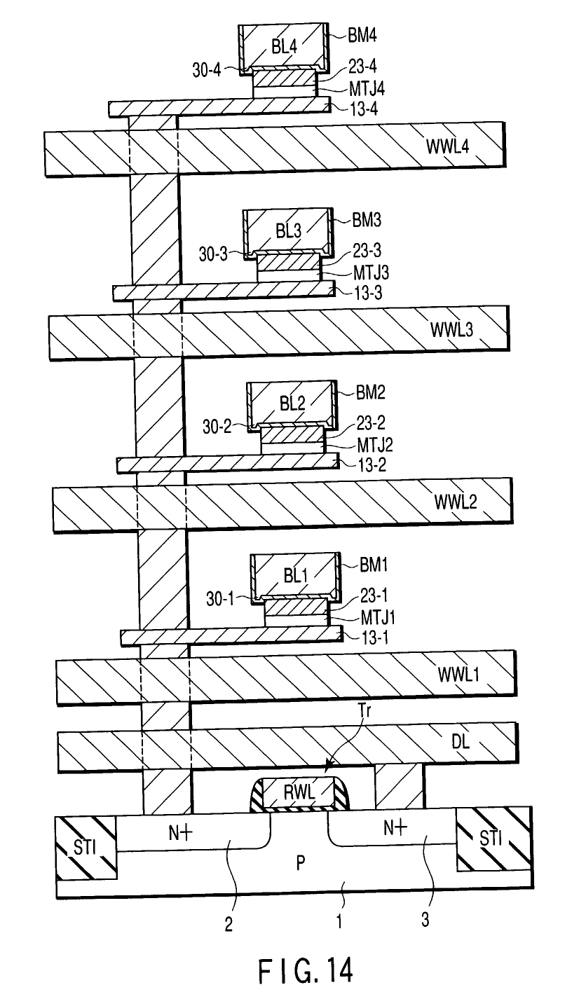

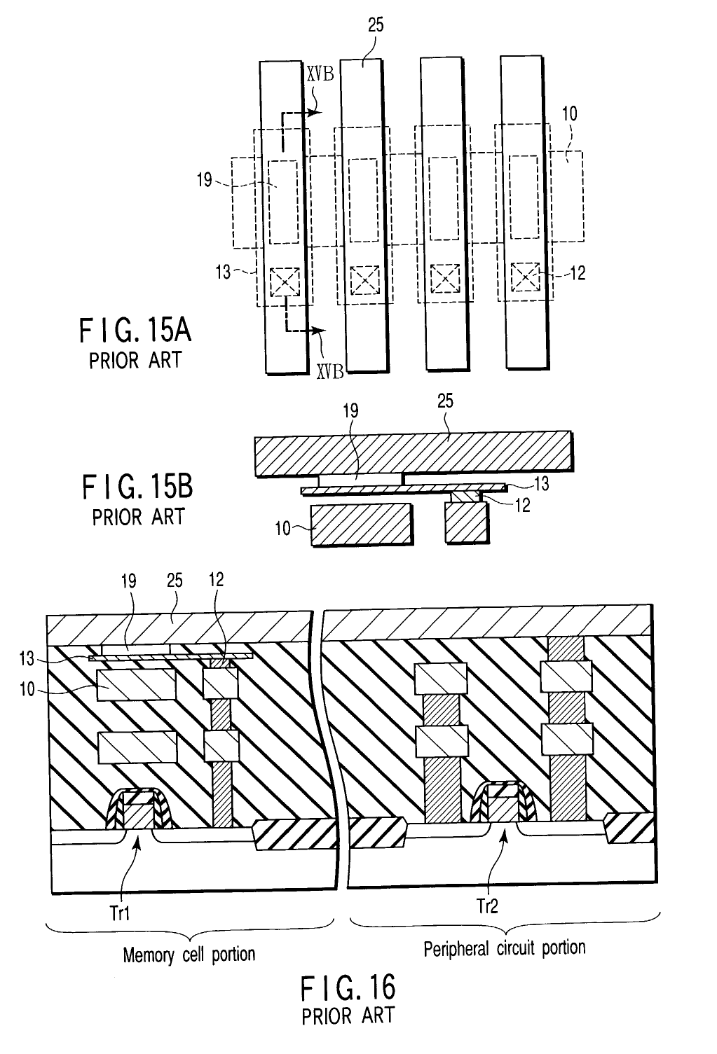

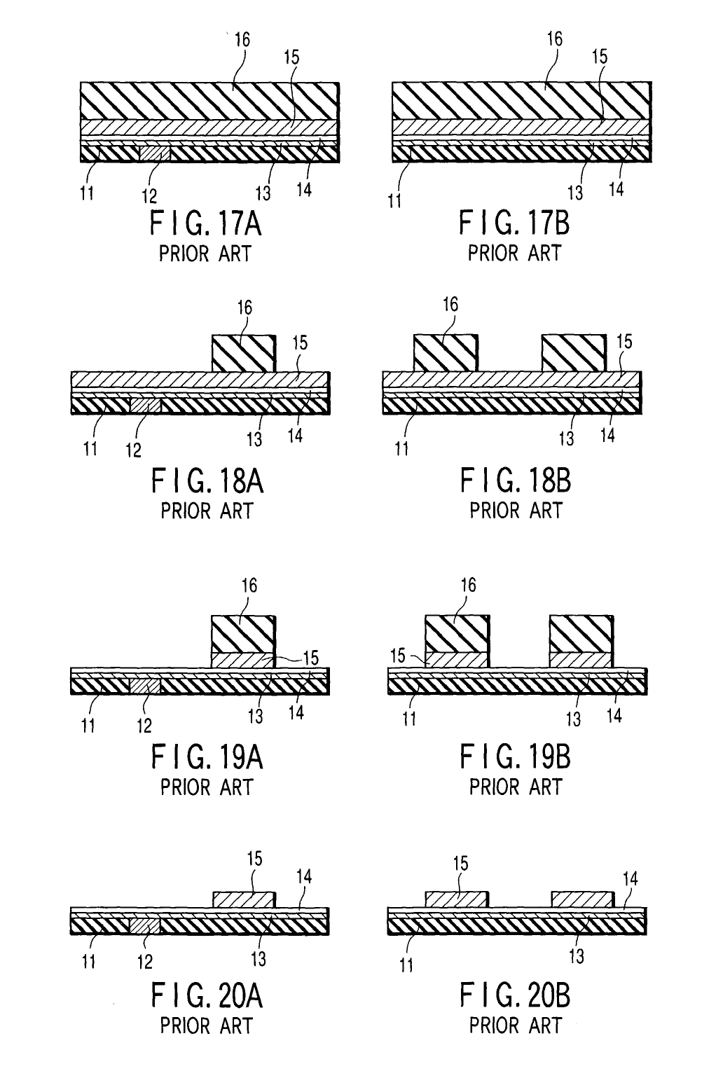

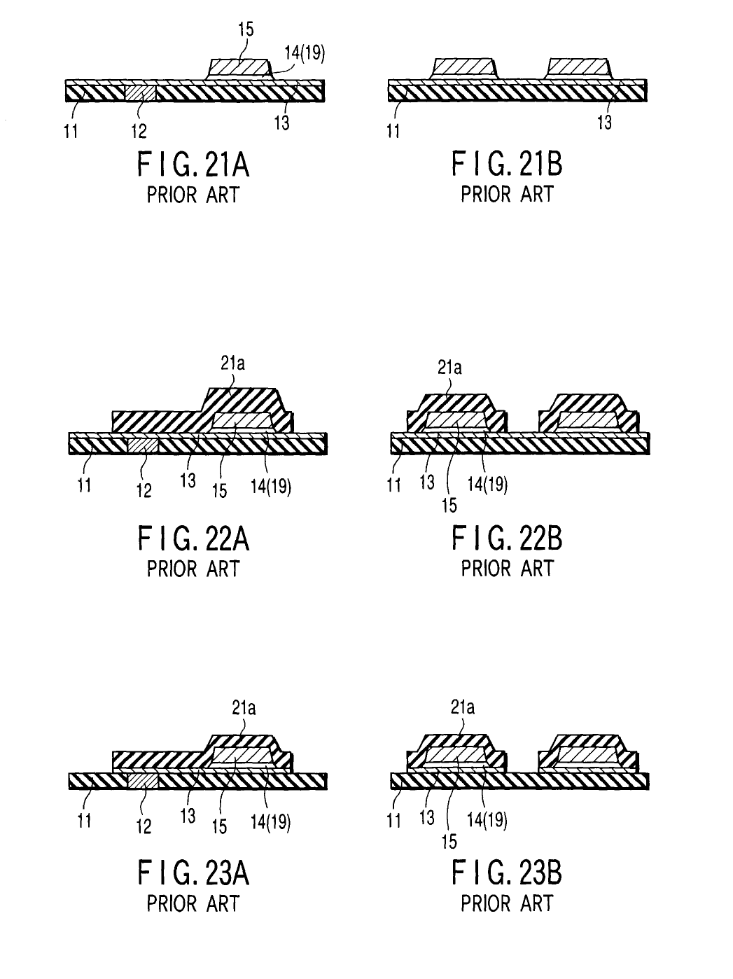

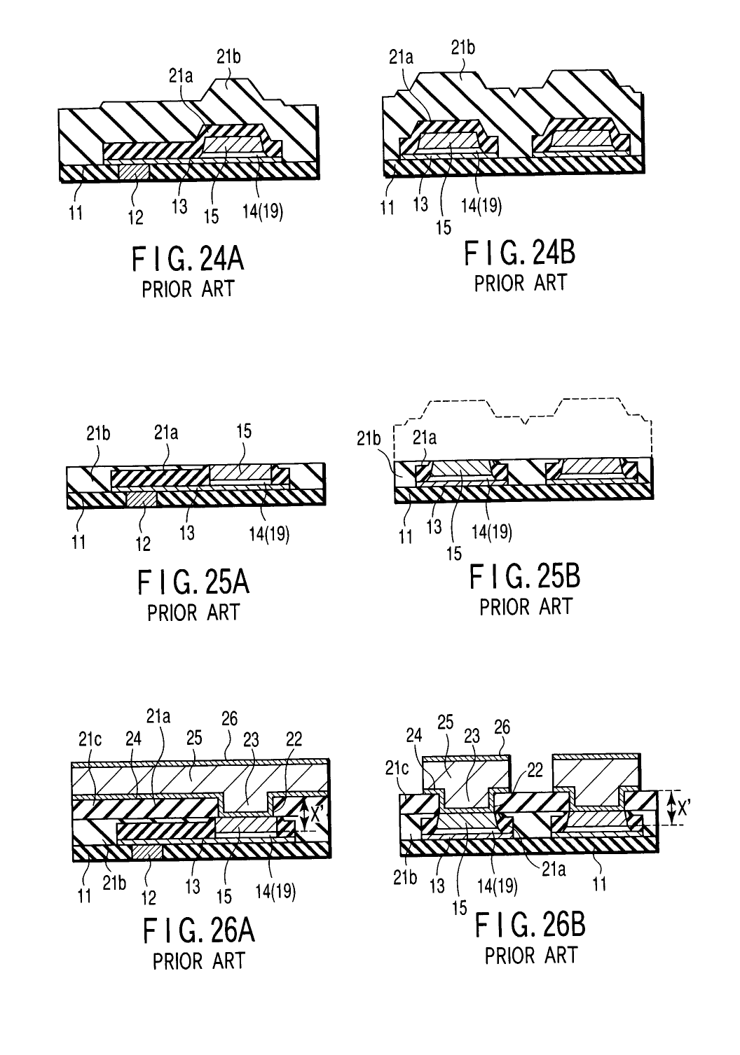

FIGS. 13 and 14 are sectional views showing a magnetic memory device according to the second embodiment of the present invention. A different structure of the second embodiment from that of the first embodiment will be described.

As shown in FIGS. 13 and 14, the second embodiment is different from the first embodiment in that MTJ elements (MTJ1, MTJ2, MTJ3, and MTJ4) are stacked in a direction (longitudinal direction) perpendicular to the surface of a semiconductor substrate 1. Four MTJ elements are stacked in the second embodiment, but the number of MTJ elements is not limited to four.

More specifically, a MOS transistor Tr as a read switching element is arranged on the surface of the semiconductor substrate 1. The gate electrode of the MOS transistor Tr acts as a read word line RWL, and a source region 3 is connected to a data transfer line DL. In FIG. 13, the read word line RWL runs in the same direction as a write word line WWL, and the data transfer line DL runs in the same direction as a bit line BL. In FIG. 14, the read word line RWL runs in the same direction as the bit line BL, and the data transfer line DL runs in the same direction as the write word line WWL.

The four MTJ elements MTJ1, MTJ2, MTJ3, and MTJ4 are stacked above the read word line RWL. The MTJ elements MTJ1, MTJ2, MTJ3, and MTJ4 are respectively interposed between lower metal layers 13-1, 13-2, 13-3, and 13-4 and contacts 23-1, 23-2, 23-3, and 23-4. The four MTJ elements MTJ1, MTJ2, MTJ3, and MTJ4 are series-connected to each other via the contacts. The lowest MTJ element MTJ1 is connected to a drain region 2 of the MOS transistor Tr via the lower metal layer 13-1 and contact, and to the data transfer line DL.

Similar to the first embodiment, each of bit lines BL1, BL2, BL3, and BL4 has a damascene structure made of, e.g., a Cu film. That is, the surface of each of the bit lines BL1, BL2, BL3, and BL4 is flush with the surface of an insulating film (not shown) which fills the periphery. The bit lines BL1, BL2, BL3, and BL4 have projections 30-1, 30-2, 30-3, and 30-4 which cover the tops of the contacts 23-1, 23-2, 23-3, and 23-4. The projections 30-1, 30-2, 30-3, and 30-4 have thicknesses 10% or more those of the contacts 23-1, 23-2, 23-3, and 23-4.

The second embodiment can obtain the same effects as those of the first embodiment.

The MTJ elements MTJ1, MTJ2, MTJ3, and MTJ1 are stacked above the semiconductor substrate 1, series-connected to each other, and share the read switching element. This can increase the memory cell density and memory capacity.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A magnetic memory device comprising:
a first wiring which runs in a first direction;
a first metal layer which is arranged above the first wiring;
a first magneto resistive effect element which is arranged in a predetermined region on the first metal layer;
a first contact layer which is arranged on the first magneto resistive effect element;
a second wiring which runs in a second direction different from the first direction, is arranged on the first contact layer, and has a projection that covers top of the first contact layer; and
a first insulating film which is buried around the first metal layer, the first magneto resistive effect element, the first contact layer, and the second wiring, and has a surface flush with a surface of the second wiring.

2. A device according to claim 1, wherein the second wiring is formed from a Cu film.

3. A device according to claim 1, wherein the projection projects from a surface of the first contact layer to the first magneto resistive effect element by not less than 10% a film thickness of the first contact layer.

4. A device according to claim 1, further comprising a barrier metal layer which is formed on bottom and side surfaces of the second wiring.

5. A device according to claim 1, wherein a planar shape of the first contact layer is substantially the same as a planar shape of the first magneto resistive effect element.

6. A device according to claim 1, further comprising:
a third wiring which is arranged above the second wiring and runs in the first direction;
a second metal layer which is arranged above the third wiring;
a second magneto resistive effect element which is arranged in a predetermined region on the second metal layer and series-connected to the first magneto resistive effect element;
a second contact layer which is arranged on the second magneto resistive effect element;
a fourth wiring which runs in the second direction and is arranged on the second contact layer; and
a second insulating film which is buried around the second metal layer, the second magneto resistive effect element, the second contact layer, and the fourth wiring, and has a surface flush with a surface of the fourth wiring.

7. A magnetic memory device manufacturing method, comprising:
sequentially forming a metal layer, a magneto resistive effect film, and a mask layer on a first insulating film;
selectively removing the magneto resistive effect film by using the mask layer to form a magneto resistive effect element;
selectively removing the metal layer to divide the metal layer into cells;
forming a second insulating film which covers the metal layer and the magneto resistive effect element;
planarizing the second insulating film to a predetermined thickness;
selectively etching the second insulating film to form a trench from which top of the mask layer is exposed; and
forming a wiring material in the trench to form a wiring having a projection which covers the top of the mask layer.

8. A method according to claim 7, wherein the wiring material includes a Cu film.

9. A method according to claim 7, wherein the trench is so formed as to project the projection by not less than 10% a film thickness of the mask layer.

10. A method according to claim 7, further comprising forming a barrier metal layer on bottom and side surfaces of the wiring.

11. A method according to claim 7, wherein the metal layer is removed using either of a photoresist and an insulating film as a mask.

12. A method according to claim 7, wherein the second insulating film is planarized to the predetermined thickness to adjust a film thickness of the second insulating film on the mask layer to a film thickness of the wiring.

13. A method according to claim 7, wherein the mask layer is formed from a conductive film.

14. A method according to claim 13, wherein a contact is formed from the mask layer in self-alignment before the trench is formed.

15. A method according to claim 7, wherein end of etching to form the trench is detected by detecting a component of the mask layer.

16. A method according to claim 7, wherein a dummy magneto resistive effect element and a dummy mask layer are arranged at the same level as the magneto resistive effect element and the mask layer at a peripheral circuit portion around a memory cell where the magneto resistive effect element is arranged, and the trench is formed.
